(19) United States
(12) Patent Application Publication
(10) Pub. No.: US 2019/0176865 A1
(43) Pub. Date: Jun. 13, 2019

(54) HYBRID DOLLY DEVICE

(71) Applicant: Edwin Stone, Kissimmee, FL (US)

(72) Inventor: Edwin Stone, Kissimmee, FL (US)

(21) Appl. No.: 15/839,859

(22) Filed: Dec. 13, 2017

(51) Int. Cl. B62B 5/00

(52) U.S. Cl. CPC B62B 5/0093; B62B 5/0457

(57) ABSTRACT

A wheeled standalone platform implement having at least two or more swivel casters, each swivel caster is into engagement at a proximate lower base portion of said platform, wherein said at least two or more swivel casters are configured to allow a movement of said platform in any direction. A slot section disposed at a mid-portion of said platform is configured to allow a toe plate of a handcart or a dolly to engage said platform. A locking mechanism is disposed to prevent the wheeled standalone platform from sliding off the toe plate during use.

### CROSS-REFERENCE TO RELATED APPLICATIONS

Not applicable.

### RELATED CO-PENDING U.S. PATENT APPLICATIONS

Not applicable.

### INCORPORATION BY REFERENCE OF SEQUENCE LISTING PROVIDED AS A TEXT FILE

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### BACKGROUND OF THE RELEVANT PRIOR ART

One or more embodiments of the invention generally relate to wheeled carts. More particularly, certain embodiments of the invention relate to a multiple use wheeled platform.

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon. When moving large or heavy items, individuals often use a handcart or a dolly. Conventional handcarts are typically tilted back to lift and move a load to a different location. A load is normally picked up by placing a toe plate under the load then pulling back on the handles of the handcart using the wheels as the point of leverage. Due to the location of the wheels of such handcarts, which are often several inches away from the weight of the load, one may expect that lifting a heavy load in this manner may be difficult. In addition, there may be a risk of losing control of the load while setting the load down as a result of the distance of the weight of the load from the point of leverage. It is believed that the toe plates on which the loads are placed on conventional handcarts may be relatively small, and in some cases a user may need to hold the load back against the frame of the handcart while pulling back on the handle to tilt the handcart until the load is resting on the frame and the toe plate. Furthermore, one may expect that tilting the handcart to move the load may require a great deal of space to maneuver and may lead to difficulty in moving the load especially in tight corners or confined spaces.

By way of educational background, an aspect of the related technology generally useful to be aware of is that some currently available handcarts are configured to be used vertically or horizontally. Small wheels at the top of the frame near the handles may allow such handcarts to be laid down horizontally and moved on four wheels, similarly to a long rectangular wheeled cart. It is believed that the longer configuration of the horizontal arrangement may be difficult to maneuver. It is further believed that it may be difficult or impossible to navigate steps or uneven terrain while the handcart is in the horizontal position. In addition, in order to transition between the horizontal and vertical positions, the load may need to be removed from the handcart.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A, 1B and 1C illustrate an exemplary multiple use wheeled platform, in accordance with an embodiment of the present invention. FIG. 1A is a rear perspective view of the wheeled platform. FIG. 1B, is a rear perspective view of the wheeled platform next to a conventional handcart, and FIG. 1C is a rear perspective view of the wheeled platform attached to the handcart; and

FIG. 2 is an exploded view of an exemplary base for a layered multiple use wheeled platform, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, it is well settle law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [“substantially”] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearwardmost point of the upper or outsole.

Similarly, the term ‘substantially’ is well recognized in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hollinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. § 112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to avoid a strict numerical boundary to the specified parameter,” see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will be described in detail below with reference to embodiments thereof as illustrated in the accompanying drawings.

References to a “device,” an “apparatus,” a “system,” etc., in the preamble of a claim should be construed broadly to mean “any structure meeting the claim terms” exempt for any specific structure(s)/type(s) that has/(have) been explicitly disavowed or excluded or admitted/implied as prior art in the present specification or incapable of enabling an object/aspect/goal of the invention. Furthermore, where the present specification discloses an object, aspect, function, goal, result, or advantage of the invention that a specific prior art structure and/or method step is similarly capable of performing yet in a very different way, the present invention disclosure is intended to and shall also implicitly include and cover additional corresponding alternative embodiments that are otherwise identical to that explicitly disclosed except that they exclude such prior art structure(s)/step(s), and shall accordingly be deemed as providing sufficient disclosure to support a corresponding negative limitation in a claim claiming such alternative embodiment(s), which exclude such very different prior art structure(s)/step(s) way(s).

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” includes the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user”, or any similar term, as used herein, is generally intended to mean late stage user(s) as opposed to early stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of, or interaction with, some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

Terminology. The following paragraphs provide definitions and/or context for terms found in this disclosure (including the appended claims):

“Comprising.” This term is open-ended. As used in the appended claims, this term does not foreclose additional structure or steps. Consider a claim that recites: “A memory controller comprising a system cache . . . ” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. sctn.112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” and “consisting of” limits the scope of a claim to the specified elements or method steps, plus those that do not materially affect the basis and novel characteristic(s) of the claimed subject matter (see Norian Corp. v Stryker Corp., 363 F.3d 1321, 1331-32, 70 USPQ2d 1508, Fed. Cir. 2004). Moreover, for any claim of the present invention which claims an embodiment “consisting essentially of” or “consisting of” a certain set of elements of any herein described embodiment it shall be understood as obvious by those skilled in the art that the present invention also covers all possible varying scope variants of any described embodiment(s) that are each exclusively (i.e., “consisting essentially of”) functional subsets or functional combination thereof such that each of these plurality of exclusive varying scope variants each consists essentially of any functional subset(s) and/or functional combination(s) of any set of elements of any described embodiment(s) to the exclusion of any others not set forth therein. That is, it is contemplated that it will be obvious to those skilled how to create a multiplicity of alternate embodiments of the present invention that simply consisting essentially of a certain functional combination of elements of any described embodiment(s) to the exclusion of any others not set forth therein, and the invention thus covers all such exclusive embodiments as if they were each described herein.

With respect to the terms “comprising,” “consisting of” and “consisting essentially of” where one of these three terms is used herein, the presently disclosed and claimed subject matter may include the use of either of the other two terms. Thus in some embodiments not otherwise explicitly recited, any instance of “comprising” may be replaced by “consisting of” or, alternatively, by “consisting essentially of”, and thus, for the purposes of claim support and construction for “consisting of” format claims, such replacements operate to create yet other alternative embodiments “consisting essentially of” only the elements recited in the original “comprising” embodiment to the exclusion of all other elements.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

While The Dolly Hybrid Device is a handcart add on, the same type innovation could be used in a new handcart design.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

An embodiment of the present invention may allow the user of the handcart to move that handcart in any direction without tilting the handcart back onto the wheels of the handcart. In some embodiments of the present invention may provide a substantially larger working platform that will allow handling of larger loads so that the load will not tip off the front of the toe plate when the handcart is tilted back. An additional embodiment of the present invention may reduce the force necessary to tilt a load back to move the handcart using the wheels of the handcart. These attributes are not confined in size and scope but may be used in different sizes or applications and the same attributes will apply to different applications. A conventional handcart toe plate of the handcart fits into the device. There may be a latch that will close behind the handcart thereby not allowing the handcart to separate from the invention until it is released by releasing the latch. While attached the handcart is no longer sitting on the ground but is now inserted into the device and rests on the device with the wheels of the handcart off the ground. The handcart will stand upright secure and stable while resting on the invention. While so attached the handcart can be moved in any direction while in the upright position thereby allowing it to move about in very small spaces safely and easily. The size of the platform can be of different sizes and will still perform the same way. As the handcart is resting on the device, it may be desirable to tilt the handcart back onto it's own large wheels to traverse, for instance, soft ground in this example. The force required to tilt the handcart back is greatly reduced because the leverage point is moved considerably closer to the load by using the rear wheels and the tilt bar of the invention. The rear wheels of the device are very close to the load thereby using leverage to advantage. The next point of leverage is the tilt bar which will contact the ground shortly after the load is tilted. The next point of leverage are the wheels of the handcart itself. This moving of the points of leverage creates a rolling motion when a load is tilted back and works in reverse when the load is lowered down again. This gives the user much more control with heavy loads with much less force required to achieve the desired goal. An embodiment of the present invention may provide a multiple use wheeled platform that can be used singly as a horizontal wheeled cart or may attach to almost any handcart to be used similarly to a conventional handcart. When used attached to a handcart, it is believed that the wheeled platform may allow the handcart to tilt back for regular use with less force than required with conventional handcarts. Moreover, in this configuration, the handcart typically does not need to be tilted back to move; the entire wheeled platform handcart assembly can be moved easily in any direction while in an upright position. This may enable the wheeled platform handcart assembly to be highly maneuverable even in confined spaces.

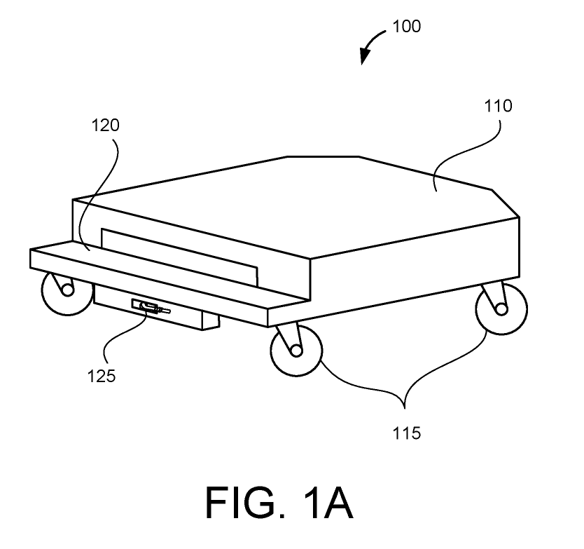

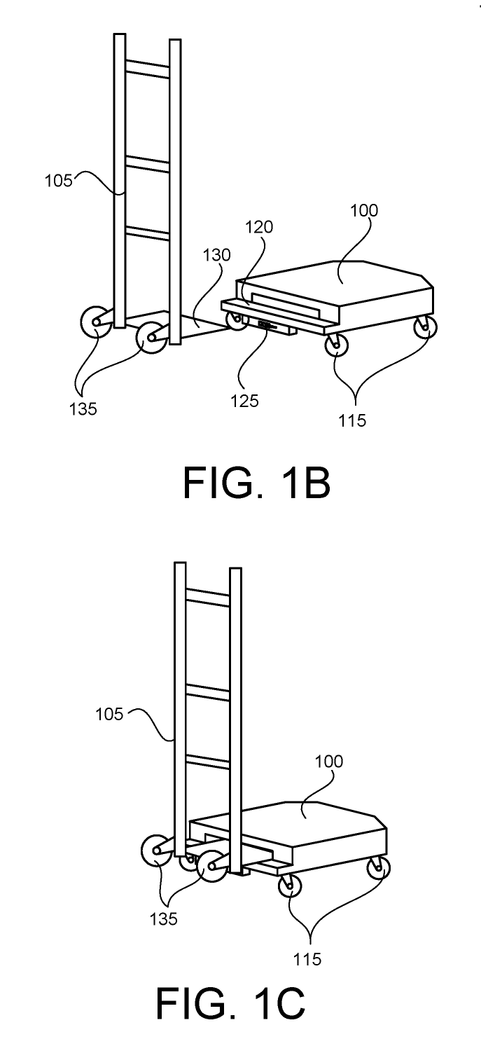

FIGS. 1A, 1B and 1C illustrate an exemplary multiple use wheeled platform 100, in accordance with an embodiment of the present invention. FIG. 1A is a rear perspective view of wheeled platform 100. FIG. 1B, is a rear perspective view of wheeled platform 100 next to a conventional handcart 105, and FIG. 1C is a rear perspective view of wheeled platform 100 attached to handcart 105. In the present embodiment, wheeled platform 100 comprises a base 110, wheels 115, a slot 120, and a locking mechanism 125. Base 110 may be generously sized to provide adequate surface area to hold most loads. For example, without limitation, in one exemplary embodiment base 110 may measure 22 inches by 23 inches. In many embodiments it may be preferred that base 110 does not exceed 23 inches in width to accommodate standard 24 inch door openings. Those skilled in the art will readily recognize, in light of and in accordance with the teachings of the present invention, that some embodiments may be made in a multiplicity of suitable sizes including, without limitation, larger and smaller sizes. Most common handcarts are relatively close in size and therefore are considered to be standard sized handcarts. Just as handcarts can be made in different sizes to accommodate different needs, so too can the size of this device, which may be adjusted to accommodate different needs. The principals and functions of this invention will apply with different size ranges and may be adjusted for a particular use. Just as the size of the individual platforms can be changed the platforms, due to their design, can be used in tandem. The surface of the platform is flat so it is easily adaptable to specific needs. As example, for extremely long or irregular items to be moved it would be possible to cut conventional plywood the same size as the irregular object to be moved. In this way it would be possible to place one of the wheeled platforms at each end and thereby making the moving of the object much easier and safer. As the top of the device can be changed in size and is flat so can be adapted in many different ways there are many scenarios where this invention would be most useful. In the present embodiment, wheels 115 may be lockable swivel casters attached to the bottom surface of base 110 at all four corners. The use of swivel casters for wheels 115 may typically allow movement of wheeled platform 100 in any direction. In addition, being able to lock wheels 115 in place may be useful when a user does not want wheeled platform 100 to move. However, in some applications wheels 115 may not be lockable wheels. Other embodiments may be implemented with a multiplicity of suitable alternate configurations for the wheels. For example, without limitation, in one embodiment the rear wheels may be unidirectional wheels while the front wheels may be swivel casters. In this embodiment, the front wheels would be used to turn the platform. In some embodiments, all of the wheels may be unidirectional. Some alternate embodiments may be implemented with more or fewer wheels. For example, without limitation, one such embodiment may comprise one wheel at each back corner of the platform with a single swivel caster in the center of the front of the platform for turning. In another example, for extremely heavy loads, the device may have three wheels on either side. The uses of the device and configurations of the wheels can be changed as needed. The wheels used in some embodiments may be of virtually any size, load capacity, roller style, or wheel surface material including, but not limited to, soft rubber, hard rubber, plastic, nylon, or steel.

Referring to FIGS. 1B and 1C, in the present embodiment slot 120 may typically enable a toe plate 130 of handcart 105 to be inserted into wheeled platform 100. Slot 120 may be sized to fit on the toe plates of many different types of handcarts. Some alternate embodiments may be implemented to fit on specific handcarts. Other alternate embodiments may provide adaptors that may be inserted into the slot to correspond with specific handcarts. In some embodiments means other than a slot may be used to accept the toe plate or to secure the toe plate to the wheeled platform such as, but not limited to, brackets, bolts, screws, rails, or clamps Other alternate embodiments may provide adaptors that may be inserted into the slot to correspond with specific handcarts. In some embodiments means other than a slot may be used to accept the toe plate or to secure the toe plate to the wheeled platform such as, but not limited to, brackets, bolts, screws, rails, or clamps. In the present embodiment once toe plate 130 is inserted into slot 120, locking mechanism 125 may be engaged to help prevent wheeled platform 100 from sliding off of toe plate 130 during use. It is contemplated that a multiplicity of suitable devices may be used for locking mechanism 125 such as, but not limited to, a spring latch assembly, one or more hooks, straps, pins, screws, bolts, barrel bolts. or various other types of latches. It is further contemplated that the locking mechanisms in some alternate embodiments may be located in alternate locations on the wheeled platform depending on various factors such as, but not limited to, the type of handcart, the type of locking mechanism, or the size of the wheeled platform, In the present embodiment, the components of wheeled platform 100 may be constructed from a multiplicity of suitable materials including, without limitation, wood, metal, plastic, or a combination of materials. In some embodiments, the wheeled platform may have a shock absorbing bumper or scratch resistant strip around the perimeter.

In typical use of the present embodiment, wheeled platform 100 may be used singly as a standalone horizontal wheeled dolly or may be attached to almost any conventional handcart and used in an upright position. Referring to FIG. 1A when wheeled platform 100 is not attached to a handcart a load may be placed on the upper surface of wheeled platform 100 so that the load may be moved by rolling wheeled platform 100 on wheels 115. Wheels 115 typically enable wheeled platform 100 to be moved in any direction. Referring to FIGS. 1B and 1C, to attach wheeled platform 100 to handcart 105, slot 120 of wheeled platform 100 may slide over toe plate 130 of handcart 105 by locking mechanism 125 so that wheeled platform typically will not slide off of toe plate 130 during use. Referring to FIG. 1C, when wheeled platform 100 is attached to handcart 105, handcart 105 is typically elevated off the ground and is supported by wheeled platform 100 to remain stable with handcart 105 upright and all four wheels 115 of wheeled platform 100 in contact with the ground. The upper rear portion of wheeled platform 100 is, in this example, two inches shorter than the lower portion. This allows the toe plate to slide into wheeled platform 100 and uses the two inches to allow the handcart to rest on the two inches of space. In this way the weight of the handcart is just inside of the rear wheels 115 of wheeled platform 100. This creates stability so the handcart will remain in an upright position even when wheeled platform 100 is empty. In this way the pivot point is much closer to the load thereby using leverage to advantage. In this configuration, wheeled platform 100 and handcart 105 may act as a highly maneuverable device that can readily adapt to different terrains and surroundings without the need to physically change the device. The handcart does not need to be tilted back to move. The device comprising wheeled platform 100 and handcart 105 typically can be moved on wheels 115 easily in any direction while in an upright position. If lockable swivel casters are used for wheels 115 wheels 115 can be locked in place when not using the device in the upright position. Using the present embodiment handcart 105 can be tilted back easily, even when heavily loaded since, when handcart 105 is attached to wheeled platform 100, the pivot point is shifted from wheels 135 of handcart 105 to rear wheels 115 of wheeled platform 100, which is closer to the load placed on wheeled platform 100. This shifted pivot point may also help maintain control of the load when returning handcart 105 to an upright position. Some embodiments may comprise a tilt bar or point of pivot near the rear wheels of the platform that may also hold the weight of the load upon tilting rather than using the rear wheels of the wheeled platform alone. In the present embodiment, the surface of wheeled platform 100 may be sizeable enough to hold larger loads easily and securely. In addition, the assembly of wheeled platform 100 and handcart 105 typically does not need to be changed in any way to shift back and forth between an upright wheeled cart and a tilted handcart. This means the present embodiment may be able to cross uneven or soft terrain, go up or down steps, maneuver around obstacles, turn sharp corners, and navigate confined spaces without the need to be modified from its simple configuration and without unloading and reloading the load. It is believed that the present embodiment may be safer than traditional approaches since a user typically does not need to reach over the load to hold the load in place and can usually remain centered with the load while trying to maneuver tight corners or confined spaces. When wheeled platform 100 is not in use, the flat design of wheeled platform 100 may enable the present embodiment to be easily stored in a small space. It is contemplated that various different types of users may be able to use the present embodiment including, without limitation, movers, small businesses, home owners, moving rental outlets, tool rental outlets, warehouses, and delivery businesses.

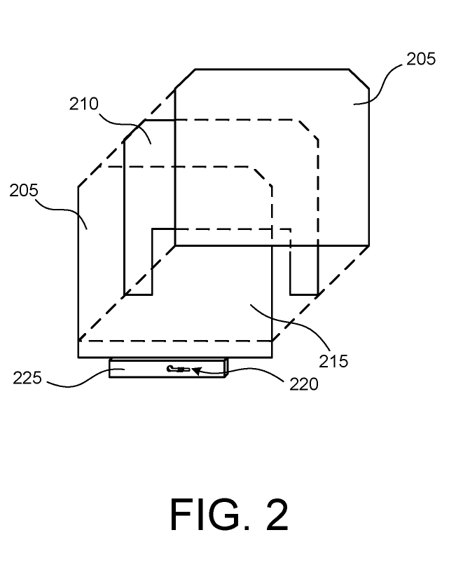

FIG. 2 is an exploded view of an exemplary base for a layered multiple use wheeled platform, in accordance with an embodiment of the present invention. In the present embodiment, the wheeled platform base may be made by attaching a solid panel 205 on each side of a notched panel 210. Panels 205 and 210 may be attached using a multiplicity of suitable means such as, but not limited to, adhesive, screws, bolts, welding, or a combination of attachment means. Once panels 205 and 210 are assembled, a notch 215 in notched panel 210 along with solid panels 205 form a slot into which a toe plate of a handcart may be inserted. The base is typically constructed to ensure there are no screws, excess glue or other materials blocking the slot. A locking mechanism 220 may be attached to a support member 225 placed on the bottom surface of the base and centered under notch 215 on the backside of the base. Locking mechanism 220 and support member 225 may be attached to the base using various different means such as, but not limited to, screws, bolts, or adhesive. The location of locking mechanism 220 is typically such that the toe plate misses locking mechanism 220 as the toe plate is inserted into the slot and that, when engaged, locking mechanism, holds the base securely onto the toe plate. Locking mechanisms in some alternate embodiments may be positioned in different locations. In some embodiments, the locking mechanisms may be placed directly on the base of the wheeled platform without a support member. In the present embodiment, a multiplicity of suitable materials may be used to form panels 205 and 210 and support member 225 including, without limitation, wood, plastic or metal. If wood is used, a coating such as, but not limited to, paint, stain, or sealer may be applied to the exposed surfaces to protect the wood. After the base is constructed, wheels (not shown), for example without limitation, lockable swivel casters, may be attached at each back corner and at each front angle corner of the base. The foregoing construction method is presented as an example of how a multiple use wheeled platform may be made, and it is contemplated that alternate embodiments may be constructed using various different methods including, without limitation, heat molding, injection molding, machining, or 3-D printing. Some of these methods may produce a one-piece base rather than a base made of multiple pieces assembled together.

The embodiments described above are directed toward standalone wheeled platforms that may be attached to existing handcarts. It is contemplated that in some embodiments handcarts may be manufactured with integrated wheeled platforms. These embodiments would look similar to the configuration illustrated by way of example in FIG. 1C. Those skilled in the art will readily recognize, in light of and in accordance with the teachings of the present invention, that there are many other modifications that may be made in alternate embodiments. For example, without limitation, in some embodiments the platforms may be made in shapes other than rectangles with angled front corners including, but not limited to, rectangles without angled corners, trapezoidal shapes, forked shapes, or rounded shapes. Other embodiments may comprise additional features or elements such as, but not limited to, built in straps, loops or hooks for tying down loads, a handle mounted to the front of the platform, all-terrain wheels, or non-slip upper surfaces. Other embodiments may include, but not limited to, bucket forks which may be for five gallon pails, thirty gallon drums, or fifty five gallon drums, or other sizes. All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC § 112 (1), all claims must be supported by sufficient disclosure in the present patent specification, and any material known to those skilled in the art need not be explicitly disclosed. However, 35 USC § 112 (6) requires that structures corresponding to functional limitations interpreted under 35 USC § 112 (6) must be explicitly disclosed in the patent specification. Moreover, the USPTO's Examination policy of initially treating and searching prior art under the broadest interpretation of a “mean for” claim limitation implies that the broadest initial search on 112 (6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC § 112 (6) when such corresponding structures are not explicitly disclosed in the foregoing patent specification. Therefore, for any invention element(s)/structure(s) corresponding to functional claim limitation(s), in the below claims interpreted under 35 USC § 112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC § 112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC § 112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC § 112 (6). Applicant(s) note that all the identified documents above which are incorporated by reference to satisfy 35 USC § 112 (6) necessarily have a filing and/or publication date prior to that of the instant application, and thus are valid prior documents to incorporated by reference in the instant application.

Having fully described at least one embodiment of the present invention, other equivalent or alternative methods of implementing a multiple use wheeled platform according to the present invention will be apparent to those skilled in the art. Various aspects of the invention have been described above by way of illustration, and the specific embodiments disclosed are not intended to limit the invention to the particular forms disclosed. The particular implementation of the wheeled platform may vary depending upon the particular context or application. By way of example, and not limitation, the wheeled platforms described in the foregoing were principally directed to manually operated implementations; however, similar techniques may instead be applied to motorized wheeled platforms, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. That is, the Abstract is provided merely to introduce certain concepts and not to identify any key or essential features of the claimed subject matter. It is submitted with the understanding that it will not be used to limit or interpret the scope or meaning of the claims.

The following claims are hereby incorporated into the detailed description, with each claim standing on its own as a separate embodiment.

1. A hybrid dolly comprising:
a hybrid dolly platform;
a wheel attached to the hybrid dolly platform;
a handcart slot in the hybrid dolly platform;
a handcart resting space integrally associated with the hybrid dolly platform.

2. The hybrid dolly of claim 1, wherein the handcart resting space is located at a rear of the hybrid dolly platform.

3. The hybrid dolly of claim 1, wherein the hybrid dolly platform has a support member attached thereto on a bottom of the hybrid dolly platform.

4. The hybrid dolly of claim 1, wherein the hybrid dolly platform is shorter in height at a rear thereof so that the handcart resting space is formed.

5. The hybrid dolly of claim 1, further comprising a handcart plate inserted within the handcart slot such that the handcart rests atop the handcart resting space thereby elevating the handcart above a ground surface.

6. The hybrid dolly of claim 1, further comprising: a handcart plate inserted within the handcart slot such that the handcart rests atop the handcart resting space thereby elevating the handcart above a ground surface, wherein the hybrid dolly platform is not attached to a motorized vehicle.

7. A hybrid dolly comprising:
a standalone loading platform;
a toe plate engagement integral with the standalone loading platform;
a movement member attached to the standalone loading platform;
a cart resting space integrally associated with the standalone loading platform.

8. The hybrid dolly of claim 7, wherein the cart resting space has a cart resting atop it when a cart toe plate engages the toe plate engagement.

9. A hybrid dolly comprising:
a standalone platform;
a wheel attached to the standalone platform;
a handcart toe plate engagement slot integrally formed in the standalone platform; and
a handcart resting space integrally associated with the standalone platform.

10. The hybrid dolly of claim 9, further comprising a handcart spring latch assembly locking mechanism.

11. The hybrid dolly of claim 9, further comprising: a handcart toe plate locking mechanism.

12. The hybrid dolly of claim 9, further comprising: a plurality of wheels attached to the standalone platform.

13. The hybrid dolly of claim 9, wherein the standalone platform is not attached to a motorized vehicle.

14. The hybrid dolly of claim 9, further comprising a handcart toe plate inserted within the handcart toe plate engagement slot such that a handcart of the handcart toe plate is elevated off of a ground.

15. The hybrid dolly of claim 9, further comprising: wherein the standalone platform is shorter in height at a rear thereof so that the handcart resting space is formed.

16. The hybrid dolly of claim 9, in which said standalone platform comprises a panel having a notched portion.

17. The hybrid dolly of claim 16, in which said standalone platform further comprises at least two panels integral with the standalone platform at each side of said notched portion.

18. The hybrid dolly of claim 17, wherein said notched portion with two solid panels forms the handcart toe plate engagement slot into which a toe plate of a handcart is inserted.

19. The hybrid dolly of claim 9, in which said standalone platform further comprises at least a support member attached to a proximate base of said standalone platform.

20. The hybrid dolly of claim 1, wherein the hybrid dolly platform has an integral support member at a bottom thereof having a handcart lock integrally associated therewith.
